(19) United States
(12) Patent Application Publication
(10) Pub. No.: US 2015/0006327 A1
(43) Pub. Date: Jan. 1, 2015

(54) SYSTEM AND METHOD FOR TRANSLATING A DESCRIPTION OF A GOOD INTO ONE OR MORE OTHER DESCRIPTIONS

(71) Applicant: Briggo, Inc., Austin, TX (US)

(72) Inventors: Charles F. Studor, Austin, TX (US); J. Kevin Nater, Austin, TX (US); Marwan Hassoun, Austin, TX (US); John S. Craparo, Georgetown, TX (US)

(21) Appl. No.: 14/373,361

(22) PCT Filed: Jan. 21, 2013
(86) PCT No.: PCT/US13/22407

§ 371 Date: Jul. 20, 2014

Related U.S. Application Data
(60) Provisional application No. 61/588,656, filed on Jan. 20, 2012.

(51) Int. Cl. G06Q 30/06

(52) U.S. Cl. CPC G06Q 30/0627
USPC 705/26.63

(57) ABSTRACT

A system for translating a first description of a good into one or more other descriptions that correspond to one or more vendors is provided. The system comprises a processing device and a memory device accessible by the processing device. The memory device contains one or more data structures configured for use in mapping the first description of the good to one or more other descriptions that correspond to one or more vendors. The processing device is configured to: receive a user input representative of the first description of the good; and map, using the received input and the data structure(s) contained in the memory device, the first description to one or more other descriptions of the good. A method for translating a first description of a good into one or more other descriptions that correspond to one or more vendors is also provided.

### TECHNICAL FIELD

This disclosure relates generally to systems and methods for translating a description of a good, such as, for example, a food or beverage product, into one or more other descriptions, and more particularly, into one or more other descriptions that correspond to one or more particular vendors of the good.

### BACKGROUND

Often times a consumer has a generic description of a good they may want to purchase, but may not know which specific goods or products of one or more vendors correspond to that generic description. Similarly, a consumer may know a good by a specific name or designation ascribed to it by one vendor, but may not know what an equivalent good or product of one or more other vendors may be. In each of these instances, in order to determine the information they need, the consumer must engage in the task of researching details of the goods or products of various vendors by, for example, making telephone calls to different vendors, going to store locations of different vendors, visiting vendor websites, and/or reviewing product information relating to the goods of different vendors. As will be appreciated, this task may prove to be a painstaking and time consuming one.

Other times, a consumer may have an order they want filled that includes a number of different goods from the same general category of goods (e.g., food products), but that comprises different types of goods from that particular category (e.g., hamburgers, chicken sandwiches, etc.). Because vendors dealing in a particular category of goods may only offer certain types of goods in that category, a consumer is left to determine whether any one particular vendor is capable of fulfilling the entire order by for example, researching the capabilities of various vendors, making telephone calls to different vendors, going to store locations of different vendors, and visiting vendor websites. Alternatively, the consumer may have to fill the order using the goods or products of multiple vendors. In either instance, and as with the scenario described above, the task of determining if the order can be filled by a single vendor or using multiple vendors to fill a single order may be a painstaking and time consuming one.

### SUMMARY

According to one embodiment, there is provided a method for translating a first description of a good into one or more other descriptions that correspond to one or more particular vendors. The method comprises the steps of: receiving a user input representative of the first description of the good; and mapping, using the received input and one or more data structures, the first description to one or more other descriptions of the good that correspond to one or more particular vendors.

According to another embodiment, there is provided a system for translating a first description of a good into one or more other descriptions that correspond to one or more particular vendors. The system comprises a processing device and a memory device accessible by the processing device. The memory device contains one or more data structures configured for use in mapping the first description of the good to one or more other descriptions of the good that correspond to one or more particular vendors. The processing device is configured to: receive a user input representative of the first description of the good; and map, using the received input and the one or more data structures contained in the memory device, the first description to one or more other descriptions of the good.

According to another embodiment, there is provided a method for identifying one or more vendors that are capable of fulfilling an order containing a plurality of different goods. The method comprises the steps of: receiving a user input representative of the order; and mapping, using the received input and one or more data structures, the order to one or more vendors that are capable of fulfilling the entire order.

According to another embodiment, there is provided a system for identifying one or more vendors that are capable of fulfilling an order containing a plurality of different goods. The system comprises a processing device and a memory device accessible by the processing device. The memory device contains one or more data structures configured for use in mapping the order to one or more vendors that are capable of fulfilling the entire order. The processing device is configured to: receive a user input representative of the order; and map, using the received input and the one or more data structures contained in the memory device, the order to one or more vendors that are capable of fulfilling the entire order.

### DESCRIPTION OF THE DRAWINGS

Preferred exemplary embodiments will hereinafter be described in conjunction with the appended drawings, wherein like designations denote identical or similar elements in the various views, and wherein:

FIG. 1 is a schematic and diagrammatic view of a system configured for performing the methodologies described herein;

FIG. 2 is a flow diagram illustrating an exemplary method for translating a first description of a good into one or more other descriptions of the good that correspond to one or more particular vendors;

FIGS. 3-5 are diagrammatic views of exemplary user interfaces that may be displayed on a user input device of the system illustrated in FIG. 1 to implement the methodologies described herein;

FIG. 6 is a diagrammatic view of an exemplary data structure for use in implementing the methodologies described herein;

FIG. 7 is a diagrammatic view of an exemplary user interface that may be displayed on a user input device of the system illustrated in FIG. 1, and that may used for displaying the results of the methodology illustrated in FIG. 2;

FIG. 8 is a flow diagram illustrating an exemplary method for identifying one or more vendors that are capable of fulfilling an order comprising a plurality of different goods; and

FIG. 9 is a diagrammatic view of an exemplary user interface that may be displayed on a user input device of the system illustrated in FIG. 1, and that may be used for displaying the results of the methodology illustrated in FIG. 8.

### DETAILED DESCRIPTION OF EMBODIMENTS

The methods and systems described herein may be used to translate a description of a good into one or more other descriptions of the good, such as, for example, descriptions that correspond to one or more particular vendors. The methods and systems may also be used to identify one or more vendors that are capable of fulfilling an order containing a plurality of different goods. For purposes of illustration and clarity, the description below will be primarily limited to the use of the methods and systems described herein for goods in the nature of food products. It will be appreciated, however, that the present disclosure is not meant to be limited to such a category of goods. Rather, the methods and systems described herein may also be used to for any number of categories or types of consumer goods, such as, for example and without limitation, beverage products, laundry detergents, and fragrances, to name just a few. Thus, it will be appreciated by those having ordinary skill in the art that the present disclosure is not meant to be limited to any one particular category or type of goods.

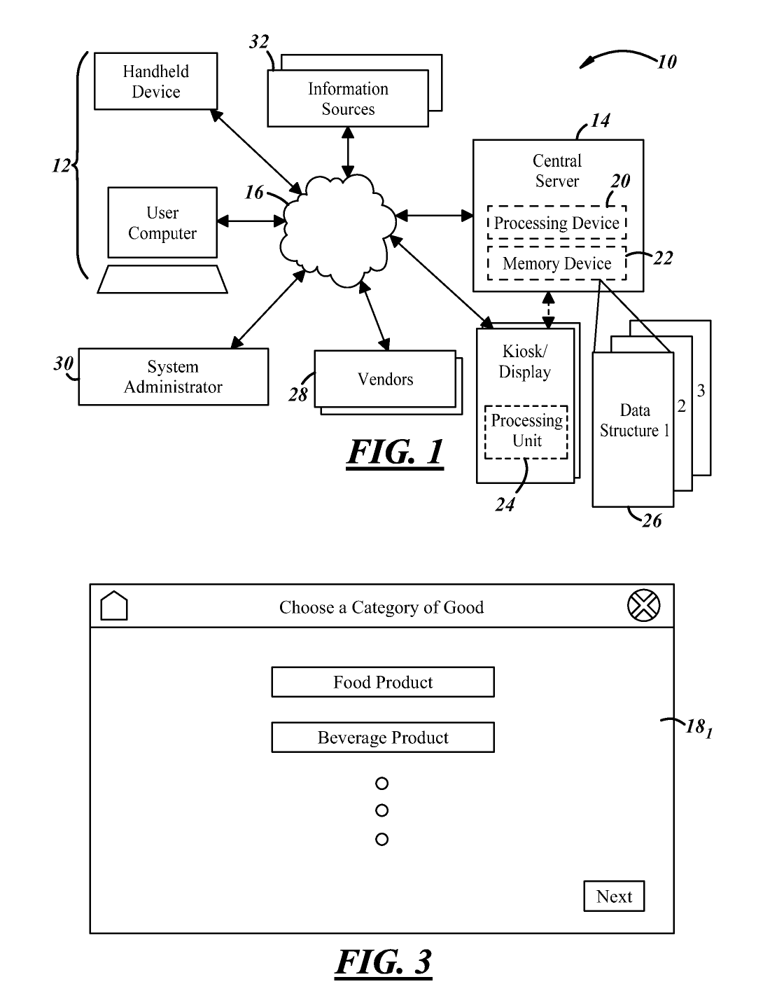

Referring now to the drawings, FIG. 1 illustrates an exemplary embodiment of a system 10 for, among other things, translating a first description of a good into one or more other descriptions. More particularly, in an exemplary embodiment, system 10 is configured to translate a first description of a good into one or more other descriptions that correspond to one or more particular vendors. In another exemplary embodiment, system 10 is additionally or alternatively configured to identify one or more vendors that are capable of fulfilling an order containing a plurality of different goods or particular types of a single good (collectively referred to herein as “different goods”). As depicted in FIG. 1, system 10 may comprise one or more user input devices 12, a central server 14, and a communication network 16 configured to facilitate communication between user input devices 12, central server 14, and, in certain embodiments, other components that may or may not be part of system 10.

As shown in the exemplary embodiment illustrated in FIG. 1, the system 10 may include one or multiple user input devices 12. While the number of user input devices that may be supported by system 10 may be unlimited, for purposes of illustration and clarity the description below will be with respect to an embodiment wherein system 10 comprises a single user input device 12. It will be appreciated, however, that the present disclosure is not meant to be so limited and that in an embodiment wherein system 10 includes multiple user input devices, the description of user input device 12 provided herein applies with equal weight to each such user input device.

User input device 12 may be electronically connected to (e.g., hardwired or wirelessly), and configured for communication with, central server 14; and may include any number of devices suitable to display or provide information to, and/or to receive information from, a user. As such, user input device 12 may comprise any combination of hardware, software, and/or other components that enable a user to communicate or exchange information with central server 14. More particularly, in an exemplary embodiment, user input device 12 may comprise one or a combination of any number of known user input devices, such as, for example: a liquid crystal display (LCD); a touch screen LCD (e.g., a 15-inch touch screen LCD); a cathode ray tube (CRT); a plasma display; a keypad; a keyboard; a computer mouse or roller ball; a joystick; a microphone; a speaker; a handheld device (e.g., telephone, smart phone, tablet, personal digital assistant (PDA), etc.); one or more switches or buttons; or any other display or monitor device. As such, it will be appreciated that user input device 12 is not limited to any one specific input device or combination of input devices.

In an exemplary embodiment, user input device 12 may comprise one or more user interfaces 18, such as a graphical user interface (GUI) and/or a text-based user interface, or may be configured to display such one or more interfaces that may be used in conjunction with one or more of the exemplary user input devices identified above (e.g., a text based user interface may be displayed on an LCD screen of a user input device and a keyboard thereof may be used in conjunction with the user interface, a GUI may be displayed on a LCD of a user input device and a mouse thereof may be used in conjunction with the user interface, etc.). In either instance, one or more components of system 10 (e.g., central server 14, a software application (hereinafter to referred to as an “app” stored on user input device 12 or elsewhere in system 10, etc.) may be configured to generate user interface 18 in the form of a graphical and/or text-based interface having one or more user-selectable or user-inputtable fields, icons, links, etc. that may be displayed on a suitable device (e.g., user input device 12 or component thereof, such as, for example, a display device) and allow a user to interact or communicate with central server 14 via text, voice, or graphical interfaces, to name a few. It will be appreciated that in an embodiment wherein user interface 18 is communicated to a user input device 12 from, for example, central server 14, it may be done so across communication network 16 using any number of well known communication techniques and protocols, such as, for example, one or more of those described below.

In any event, and regardless of the particular form it takes, user input device 12 is operable to provide an interactive interface that allows a user to interact with central server 14 for the purposes described below. For instance, user input device 12 may be configured to display a message prompting a user to input certain information (e.g., user identifying information, an indication of the particular good the user is interested in, etc.), and to also provide a means by which such information may be inputted (e.g., user-selectable or user-inputtable fields, icons, or links). The input provided by the user may then be communicated to central server 14, which may take certain action in response to the received input. As described elsewhere herein, the communication between user input device 12 and central server 14 may be supported or facilitated by any number of well known communication techniques and protocols, such as, for example, one or more of those described below.

Central server 14, which may be a standalone component or a part of either another component of system 10 or a larger network or system, may be used to control, govern, or otherwise manage certain operations or functions of system 10. Central server 14 may be implemented with a combination of hardware, software, firmware, and/or middleware, and according to an exemplary embodiment, includes a processing device 20 and a memory device 22. In one embodiment, memory device 22 is a component of processing device 20; in another exemplary embodiment, however, memory device 22 is separate and distinct from processing device 20 but accessible thereby.

Processing device 20 may include any type of suitable electronic processor (e.g., a programmable microprocessor or microcontroller, an application specific integrated circuit (ASIC), etc.) that executes instructions for software, firmware, programs, algorithms, scripts, etc. Processing device 20 may further include an input/output (I/O) interface through which it may receive and transmit input and output signals, such as, for example, those communicated between user input device 12 and central server 14, or between central server 14 and other components that may or may not be part of system 10, including, but not limited to, those described in greater detail below.

Memory device 22 may include any type of suitable electronic memory means and may store a variety of information and data. This includes, for example: one or more data structures; software, firmware, programs, algorithms, scripts, and other electronic instructions; etc. In an exemplary embodiment, the electronic instructions and/or other information (e.g., data structures) needed for performing or carrying out the methods described herein may also be stored or otherwise maintained in memory device 22.

As briefly described above and as will be described in greater detail below, central server 14 is configured communicate with user input device 12, as well as, in certain embodiments, other components that are part of system 10 or otherwise. It will be appreciated by those having ordinary skill in the art that such communication may be across communication network 16 and may be supported or facilitated by any number of well known communication techniques and protocols, such as, for example, one or more of those described below. To that end, central server 14 and user input device 12 may include, or be electronically connected to and configured for communication with, certain communication-supporting infrastructure (e.g., one or more known components or devices, such as, for example, routers, modems, antenna, electrical ports, transceivers, etc.) to facilitate such communication.

In any event, communication network 16 may comprise a wired or wireless network, such as, for example: suitable Ethernet networks; radio and telecommunications/telephony networks, such as, for example, cellular networks, analog voice networks, or digital fiber communications networks; storage area networks, such as, for example, Fibre Channel SANs; or any other suitable types of networks and/or protocols (e.g., local area networks (LANs); wireless local area networks (WLANs); broadband wireless access (BWA) networks; personal area networks (PANs), such as, for example, Bluetooth; etc.). Communication network 16 may be configured for use with one or more standard communications technologies and protocols, and may utilize links using technologies such as, for example, Ethernet, IEEE 802.11, integrated services digital network (ISDN), digital subscriber line (DSL), and asynchronous transfer mode (ATM), as well as other known communications technologies. Similarly, the networking protocols used on a communications network 16 may include multi-protocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP), among other network protocols. The data exchanged over communication network 16 may be represented using technologies, languages, and/or formats, such as the hypertext markup language (HTML), the extensible markup language (XML), and the simple object access protocol (SOAP) among other data representation technologies. Additionally, all or some of the links or data may be encrypted using any suitable encryption technologies, such as, for example, the secure sockets layer (SSL), Secure HTTP and/or virtual private networks (VPNs), the international data encryption standard (DES or IDEA), triple DES, Blowfish, RC2, RC4, R5, RC6, as well as other known data encryption standards and protocols. In other embodiments, custom and/or dedicated data communications, representation, and encryption technologies and/or protocols may be used instead of, or in addition to, the particular ones described above. Further, it will be appreciated that in an exemplary embodiment, central server 14 and user input device 12 may each be configured to communicate with the other using more than one communication technique or protocol as a fail-safe so as to provide redundancy and flexibility in the event a given technique or protocol is rendered unusable for any reason, or different components communicate using different protocols or techniques.

It will be further appreciated that depending on the particular implementation of system 10, the distance from a user interface device 12 to central server 14, or from one of these components to another component with which it communicates, may range from a matter of feet to an unlimited number of miles. Accordingly, the particular communication techniques and protocols used may depend in large part on the relative distance between the devices or components that are communicating with each other, as well as on the availability of certain infrastructure required for the various techniques/protocols (e.g., cellular reception, existence of PSTN lines, etc.).

In addition to user input device 12, central server 14, and communication network 16, in an exemplary embodiment such as that illustrated in FIG. 1, the system 10 may further comprise one or more distributed processing units 24 that are configured, at least in part, to perform some or all of the functionality of central server 14, including, in some embodiments, the methods described below. More particularly, in an exemplary embodiment, system 10 may include one or more kiosks or displays disposed at various locations (e.g., in stores, malls, airports, offices, or other public or private places) that may be in close proximity to (e.g., a matter of feet), or remotely from (e.g., a matter of many miles), central server 14, and each such kiosk or display includes a processing unit 24. In an exemplary embodiment, each processing unit 24 has the same general structure as central server 14 described above (e.g., processing device and memory device), and thus, the description of central server 14 set forth above applies to processing units 24 with equal weight and will not be repeated; rather, it is incorporated here by reference.

In any event, central server 14 may be electronically connected to (i.e., hardwired or wirelessly), and configured for communication with, each processing unit 24 such that central server 14 may communicate certain data or information to processing unit(s) 24. In an exemplary embodiment, this information may include, for example, certain electronic instructions and other stored information needed to perform the methods described herein. The communication between central server 14 and processing unit(s) 24 may be facilitated or enabled by or through a dedicated communication link or connection between the components. Additionally, or in the alternative, in an exemplary embodiment wherein processing unit(s) 24 are connected or have access to communication network 16, communication between central server 14 and processing unit(s) 24 may be facilitated or enabled by or through communication network 16. In either instance, such communication may be supported or facilitated by any number of well known communication techniques and protocols, such as, for example, one or more of those described above, and to that end, each processing unit 24 may include, or be electronically connected to and configured for communication with, certain communication-supporting infrastructure (e.g., one or more known components or devices, such as, for example, routers, modems, antenna, electrical ports, transceivers, etc.) to facilitate such communication.

In addition to processing unit 24, in an exemplary embodiment, each kiosk/display may further include a user input device 12 as a component thereof, and/or may be configured to interface with a user input device 12 that is separate and distinct therefrom. In either instance, user interface device 12 may be configured to communicate with central server 14 indirectly through the processing unit 24 to carry out the functionality and methods described herein (as opposed to user input device 12 communicating directly with central server 14 as described above). Alternatively, however, in certain other embodiments such as that described below, user input device 12 does not communicate with central server 14 at all, but rather only communicates locally with processing unit 24.

In an exemplary embodiment, by networking central server 14 with kiosks/displays such as those described above, a distributed server/computing structure may be created that may be used to perform, for example, various functions, interfacing, data storage, data caching, and data retrieval. In an exemplary embodiment, this may be achieved using various known data duplication and synchronization techniques.

More particularly, when a new kiosk/display, and thus, processing unit 24, is installed in system 10, a new network node (i.e., server or computing node) is effectively created that may perform some or all of the methods described herein, store data, etc. In an exemplary embodiment, each time a node is added to system 10, a corresponding IP address is assigned to that node by central server 14. The IP address may be a static IP address, or alternatively, a dynamic IP address, in embodiments in which a dynamic domain name service (DNS) is utilized. Accordingly, in general terms, all that may be necessary when a new kiosk/display is added to system 10 is the updating of geographically-based DNS entries to include that particular device.

In an exemplary embodiment, processing unit 24 of each kiosk/display is configured with data architecture and fail safe mechanisms that allow for redundancy and continued operation of kiosk/display, and therefore, the continued performance of the functionality described below, in the event the central server 14, or the communication between central server 14 and the kiosk/display is compromised for any reason, such as, for example, central server 14 is not operating properly (or at all), all or part of the communication network 16 is unavailable, communication between central server 14 and the distributed processing units 24 is disturbed or slow, etc.

More particularly, in an exemplary embodiment, central server 14 stores various types of information that may be required for the methods described herein to be performed at the kiosk/display. This information may include, for example, the content of certain required data structures and instructions for performing the methods described below. In an exemplary embodiment, rather than only storing such information at central server 14 and providing it to the kiosk(s)/display(s), and the processing units 24 thereof, in particular, in response to a request to do so or on as needed basis, each processing unit 24 may be configured to locally cache (e.g., in a memory or other suitable storage device thereof or that accessible thereby) all of the necessary information required for it to operate independently of central server 14 in the event communication between the kiosk/display and control server 14 is compromised. To that end, in an exemplary embodiment, each kiosk/display and central server 14 may be automatically synchronized with each other periodically so that the information/data stored at the kiosk/display is as up to date as possible. The components may additionally or alternatively be synchronized each time a triggering event occurs, such as, for example, central server 14 determines a change has been made to the information/data that the kiosk(s)/display(s) may need, or upon a request to do so from a kiosk/display.

One of advantage of the above described architecture and configuration is that the kiosk(s)/display(s) may maintain seamless continuous operation if there is a problem with the network 16 or central server 14. Accordingly, if the network 16 or central server 14 experiences problems, kiosk/display is able to continue operating for inquiries placed locally at the kiosk/display through a user input device 12 thereof, or through other user input devices 12 that may be connected to the kiosk/display through, for example, a local network (e.g., Bluetooth, Wi-Fi, etc.) to which the processing apparatus 24 of the kiosk/display is also connected (i.e., as opposed to processing unit 24 communicating with central server 14 to perform some or all of the necessary functionality).

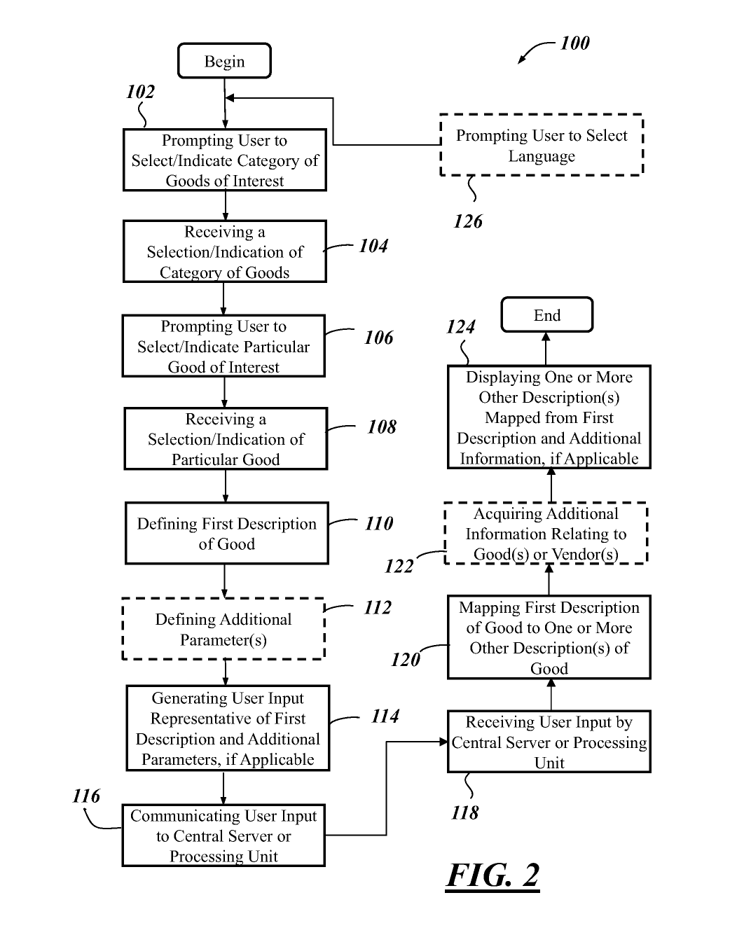

Referring now to FIG. 2, an exemplary embodiment of a methodology that may be implemented or performed using the system 10 will be described. More particularly, FIG. 2 illustrates a method 100 for translating a first description of a good into one or more other descriptions, which, in an exemplary embodiment, correspond to one or more particular vendors. It should be noted that while certain steps of method 100 will be described as being performed or carried out by central server 14 of system 10, in certain embodiments wherein system 10 includes one or more kiosks or displays, processing units 24 thereof may also be configured to perform or carry out some or all of those steps. Accordingly, it will be appreciated that the present disclosure is not meant to be limited to an embodiment wherein only central server 14 performs these steps, but rather embodiments wherein a processing unit 24 of a kiosk/display performs some or all of the steps remain within the spirit and scope of the disclosure.

According to one embodiment, method 100 comprises a first step 102 of prompting a user to select or otherwise indicate a particular category of goods that is of interest to the user. For example, a user may be prompted to select from a plurality of different categories of goods, such as, for example, food products, beverage products, laundry detergents, or any other category of consumer goods that is/are supported by system 10 and method 100. It will be appreciated that in certain instances, step 102 may not be required. For example, in an embodiment wherein only one category of goods is supported (e.g., food products), selecting or indicating a category of goods would be superfluous as there would only be one category to choose from. In such an instance, method 100 would begin at step 106 described below rather than step 102. However, in an embodiment that includes step 102, following the prompting of the user to make a selection or to otherwise provide an indication of a category of goods, method 100 includes step 104 of receiving such a selection or indication from the user.

Steps 102 and 104 may be performed or implemented in a number of ways. In one exemplary embodiment, and with reference to FIG. 3, the user may be presented with a user interface, such as, for example, user interface 18 described above and identified in FIG. 3 with reference number 18₁, that both prompts the user to make a selection or to indicate the category of goods of interest (step 102), and allows the user to make such a selection or indication (step 104). More particularly, the user interface may contain one or more a user-inputtable or user-selectable fields (e.g., drop down menus, radio buttons, check boxes, text boxes, etc.) that the user may utilize to make a selection or otherwise identify the category of interest. The user interface may be displayed on a user input device, such as user input device 12 described above, and may be generated and displayed in response to the accessing of a website through a web browser (e.g., a website hosted on central server 14), upon the launching of an app stored locally on user input device 12, or in any other way known in the art.

In an exemplary embodiment, the user's selection is communicated from user input device 12 to central server 14 (or, in certain embodiments, the processing apparatus 24 of a kiosk/display) where it is processed and acted on accordingly. Alternatively, rather than communicating the user's selection to central server 14 at this point, the selection may be processed and acted upon locally on user input device 12 through an app stored thereon and not communicated to central server 14.

In any event, in response to the user's selection of a particular category of goods, or in an embodiment wherein only one category of goods is supported, method 100 includes a step 106 of prompting a user to select or otherwise identify a particular good of interest within the selected category. For example, in an embodiment wherein the selected category is “food products,” a user may be prompted to select from a plurality of different types of food products, such as, for example, hamburgers, cheeseburgers, chicken sandwiches, etc. Following the prompting of the user to make a selection or to otherwise provide an indication of a category of good, method 100 includes step 108 of receiving such a selection or indication from the user.

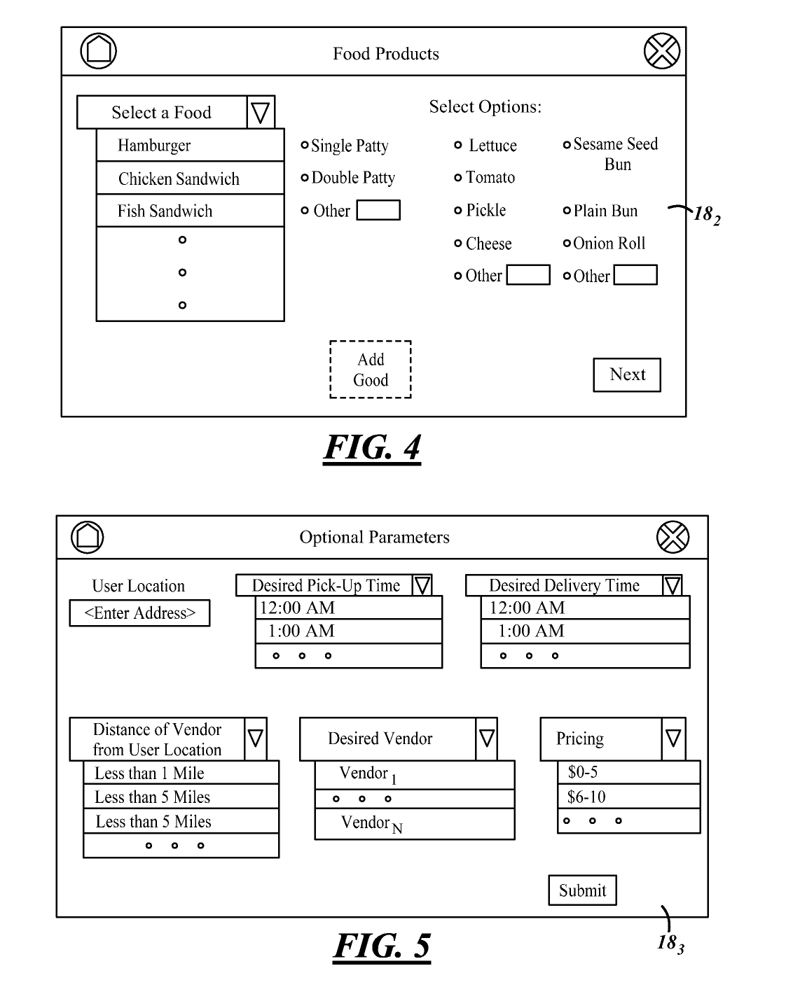

As with steps 102 and 104 described above, steps 106 and 108 may be performed or implemented in a number of ways. In one exemplary embodiment, the user may be presented with a user interface, such as, for example, user interface 18 described above that both prompts the user to make a selection or to indicate the particular good of interest (step 106), and allows the user to make such a selection or indication (step 108). In one embodiment, the same user interface used in steps 102 and 104 may be utilized to perform steps 106 and 108. Alternatively, a different user interface, such as, for example, user interface 18₂ illustrated in FIG. 4, may be utilized. In any event, and as with user interface 18₁ described above, the user interface used to select or identify a particular good may contain one or more a user-inputtable or user-selectable fields (e.g., drop down menus, radio buttons, check boxes, text boxes, etc.) that the user may utilize to make a selection or otherwise identify the particular good. The user interface may be displayed on a user input device, such as user input device 12 described above, and may be generated and caused to be displayed by, for example, central server 14 or an app on the user input device in response to the selection made in step 104, or in any other way known in the art. In an exemplary embodiment, the user's selection of a particular good is communicated from user input device 12 to central server 14 where it is processed and acted on accordingly. Alternatively, rather than communicating the user's selection to central server 14 at this point, the selection may be processed and acted upon locally on user input device 12 through an app stored thereon and not communicated to central server 14.

Once a particular good has been selected, method 100 comprises a step 110 of defining a first description of the good, which may take any number of forms. For instance, in an exemplary embodiment, the description is a generic one containing a deconstruction of the good to its constituent parts or ingredients using generic terms. In such an embodiment, the description may comprise a list of various attributes or features of the good. For example, in an instance where the good is a food product such as a hamburger, the description may comprise a list of ingredients or toppings for the hamburger (e.g., a hamburger having one patty, lettuce, tomato, and a sesame seed bun). In another instance where the good is a beverage product such as a brewed beverage, the description may comprise the type of brewed beverage along with a list of the type and amount of certain ingredients or additives for the beverage (e.g., a latte with chocolate flavoring).

In another exemplary embodiment, rather than describing the good in generic terms, the description may be specific to a particular vendor. In such an embodiment, the description may comprise, for example, a name or designation by which the particular vendor refers to the good (e.g., a menu item name). For instance, in an example such as that described above where the good is a hamburger, rather than describing the hamburger based on its constituent parts, the description may comprise the name that a certain vendor uses for that hamburger (e.g., Whopper®, Quarter Pounder®, etc.). Accordingly, it will be appreciated that the first description of the good may take any number of forms that remain within the spirit and scope of the present disclosure, including, but not limited to, those described above.

The defining of a first description of a good in step 110 may be performed or implemented in a number of ways. In one embodiment, the same user interface used in some or all of the steps described above, such as, for example, user interface 18₂ illustrated in FIG. 4, may be utilized to perform step 110. Alternatively, a different user interface may be utilized. In any event, the user interface used to define the description of the good may contain one or more a user-inputtable or user-selectable fields (e.g., drop down menus, radio buttons, check boxes, text boxes, etc.) that the user may utilize to define the description of the good. For example, user interface 18₂ depicted in FIG. 4 contains a plurality selectable radio buttons, each of which corresponds to a respective option for a hamburger. Accordingly, a user may select those options they want included in their description. The user interface used in step 110 may be displayed on a user input device, such as user input device 12 described above, and may be generated and caused to be displayed by, for example, central server 14 or an app on the user input device in response to the selection made in step 108, or in any other way known in the art.

In another exemplary embodiment, rather than manually constructing a definition for the good in step 110, the user may be able to access one or more previously constructed definitions that correspond to one or more users and that are part of a group profile. These descriptions may be stored on central server 14 (e.g., in memory device 24) and/or, in certain embodiments, processing units 24. Additionally, or in the alternative, the descriptions may be stored on user input device 12 that might include, for example, a group profile from a social networking environment. In any instance, a desired description may be selected by the user using user input device 12 in the same manner described above with respect to the creation of a definition (e.g., utilizing a user interface displayed on a user input device).

In addition to defining a description of the good itself, in an exemplary embodiment method 100 may further include an optional step 112 in which additional parameters relating to the good may be defined. In an instance wherein a user is using method 100 to not only identify goods of one or more particular vendors that correspond to a given description, but to also find a vendor from which to obtain the good, certain parameters may have a bearing on the decision the user ultimately makes. These parameters may include, for example and without limitation: a desired vendor; a desired time for having the good delivered to a particular location; a desired time for picking up the good at a certain location; desired pricing for the good; a location of the user; a desired location of a vendor; a relative distance between a given location and a vendor; and the like. Accordingly, a user may tailor the translation of the first description of the good performed in the steps of method 100 described below to maximize the usefulness of the methodology.

As with step 110, step 112 may be performed or implemented in a number of ways. In one exemplary embodiment, the user may be presented with a user interface, such as, for example, the exemplary user interface 18 described above. The user interface may be the same interface used in some or all of the steps described above, or may comprise a different interface, such as, for example, user interface18₃ illustrated in FIG. 5, which the user may navigate to from another interface, such as, for example, interface 18₂ in FIG. 4 (i.e., the user may navigate from interface 18₂ to interface 183 by selecting the “Next” button at the bottom of interface 18₂). In any event, and with reference to user interface 18₃ in FIG. 5 as an example, the user interface may contain one or more user-inputtable or user-selectable fields (e.g., drop down menus, radio buttons, check boxes, text boxes, etc.) that the user may utilize to define additional parameters. For example, the user interface may include a text box for a user to enter an address of a certain location (e.g., the user's current location). Alternatively, in an embodiment wherein the user input device being used is configured with a location service (e.g., GPS), this information may be automatically acquired by the user input device itself. Similarly, the user interface may include a series of user-selectable fields to define additional parameters, such as, for example, desired vendor, desired delivery time, and desired pricing, to name but a few. Accordingly, a user may select those parameters that are of interest to them and that they want to be taken into account in subsequent steps of method 100 described below.

With respect to steps 110 and 112, and as with steps 102-108 described above, the user interface(s) utilized to define or select the first description of the good and, if applicable, to define additional parameters of interest, may be displayed on a user input device, such as user input device 12 described above, and may be generated and caused to be displayed by, for example, central server 14 or an app on the user input device in response to the selection(s) made in steps 108 and/or 110, or in any other way known in the art.

Turning back to FIG. 2, once the first description of the good and, if applicable, one or more additional parameters has/have been defined in steps 110 and 112, method 100 comprises a further step 114 of generating a user input or user input signal that is representative of at least the first description of the good, and in certain instances, the first description of the good and any additional user-defined parameters. Following the generation of the user input in step 114, the user input is communicated, in a step 116, from user input device 12 to central server 14 (or, in certain embodiments, processing unit 24 of a kiosk/display of system 10) using well known communication techniques and protocols such as, for example, those described above. In an exemplary embodiment, the user input is communicated across communication network 16. Further, in an exemplary embodiment, steps 114 and 116 may be precipitated by, and performed in response to, a command from the user made through user input device 12, and one or more user-inputtable or user-selectable fields of a user interface thereof, in particular (e.g., the “Submit” button of user interface 18₃ depicted in FIG. 5).

In addition to the steps described above, method 100 further comprises a step 118 of receiving the user input generated in step 114 and communicated or transmitted in step 116. As described above, this user input may be received by, for example, central server 14 or, in certain embodiments, a processing unit 24 of a kiosk/display of system 10. In either instance, the received user input is processed by a processing device, such as, for example, processing device 20 of central server 14 or, if applicable, that of processing unit 24, and the content thereof is used to translate the first description of the good into one or more other descriptions that, in an exemplary embodiment, correspond to one or more particular vendors. More particularly, a step 120 of method 100 comprises using the received user input and one or more data structure to map the first description of the good to one or more other descriptions of the good that correspond to one or more particular vendors. In other words, a first description of a good can be mapped to the good of a particular vendor or to goods across multiple vendors, to find products/goods that are equivalent to the first description of the good. In an embodiment wherein the user input is representative of both the first description of the good and one or more additional user-defined parameters, step 120 comprises mapping the first description and the additional parameter(s) to the other descriptions of the good.

The description(s) to which the first description is mapped in step 120 may take any number of forms. For example, each description may comprise a name or designation by which a particular vendor refers to the good (e.g., a menu item name). For instance, and as was described above with respect to the defining of the first description of the good, in an example where the good is a hamburger, the description to which the first description is mapped may comprise the name that a certain vendor uses for that hamburger (e.g., Whopper®, Quarter Pounder®, etc.). Alternatively, rather than comprising a particular name for the good, the description may comprise a listing of ingredients or attributes/features of the vendor's equivalent good. In either instance, the description to which the first description is mapped may also include an identification of any differences between the first description and the description of the vendor's good. For example, if the first description included a sesame seed bun, but the closest equivalent good of a particular vendor has a plain bun, the description corresponding to that vendor may indicate that its good has a plain bun, not a sesame bun. Accordingly, it will be appreciated that the description(s) to which a first description of a good is mapped may take any number of forms that remain within the spirit and scope of the present disclosure, including, but not limited to, those described above.

As described above, step 120 involves the use of one or more data structures to perform the required mapping of the first description of the good to one or more other descriptions. In an embodiment wherein central server 14, and processing device 20 thereof, in particular, is performing step 120, the data structure(s) may be stored in memory device 22 of central server 14 (as is illustrated in FIG. 1 wherein data structure(s) 26 are shown being stored in memory device 22), or in another suitable memory device that is accessible by processing device 20. Similarly, in an embodiment wherein a processing unit 24 of a kiosk/display, and a processing device thereof, in particular, is performing step 120, the data structure(s) may be stored in a memory device of processing unit 24, or in another suitable memory device that is accessible by the processing device.

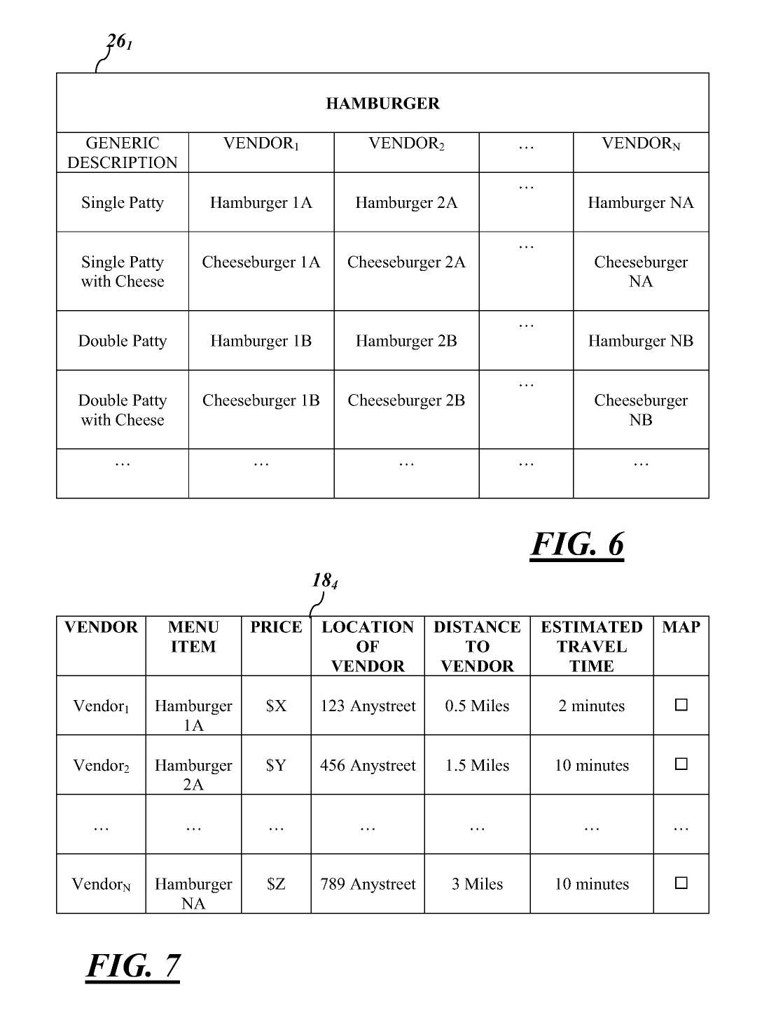

In an exemplary embodiment, a single data structure (e.g., look-up table), such as, for example, data structure 26₁ illustrated in FIG. 6, may be utilized in step 120; while in another embodiment multiple data structures (e.g., look-up tables) may be utilized (e.g., one data structure for each category of goods or each particular type of a good, one data structure for each vendor, different data structures based on the parameters to be taken into account in mapping, etc.). In either instance, each data structure may comprise a single- or multi-dimensional data structure, and may be populated with content in a number of ways. In an exemplary embodiment, an authorized vendor (referenced in FIG. 1 with reference number 28) may access data structure(s) 26 through, for example, a web portal or any other means known in the art, and may provide the necessary information corresponding to their goods. For example, a vendor may be presented with a user interface that contains a plurality of user-inputtable or user-selectable fields that the user may use to provide or enter information. In one such embodiment, the user may be presented with a generic description of a good and prompted to enter either the name or designation the vendor uses to refer to such a good, or any other description of the vendor's good that corresponds to the generic description. Alternatively, rather than the vendor providing or entering the information themselves, a system administrator (referenced in FIG. 1 with reference number 30) may provide or enter the information on the vendor's behalf directly at central server 14, or the administrator may access data structure(s) 26 through, for example, a web portal or using any other means known in the art.

Whether the vendor information is provided by the vendor or a system administrator, it may include, for example and without limitation: names or designations the vendor uses to refer to their good(s); generic descriptions of their good(s); store location(s) where the good(s) may be obtained; current wait times for good(s) or delivery; pricing information; differences between their good(s) and certain other goods; or any other information that the data structure(s) may require or support. Accordingly, the data structure(s) used in step 120 are not limited in either number or content; rather any number of data structures containing any number of different types of content or information may be used depending, in part, on the particular implementation of system 10 and method 100.

For purposes of illustration only, a simple example will now be provided of the performance of step 120 utilizing data structure 26₁ depicted in FIG. 6. In this example, the good of interest is a hamburger. As can be seen in FIG. 6, data structure 26 contains different generic descriptions of different types of hamburgers, as well as descriptions of the goods of various vendors corresponding to the generic descriptions, wherein the vendor descriptions comprise specific names of menu items ascribed by the respective vendors. In a first instance, a user input is received in step 118 that is representative of a generic description of a hamburger that comprises “a single patty with cheese.” In step 120, using the aforementioned description and data structure 26₁, the “single patty with cheese” description can be mapped to “Cheeseburger 1A” of Vendor₁, “Cheeseburger 2A” of Vendor₂, and “Cheeseburger NA” of Vendor_{N}. In a second instance, a user input is received that is representative of a description of a hamburger that corresponds to a particular vendor, namely, “Hamburger 2A.” In this instance, and using the description “Hamburger 2A” with data structure 26₁, step 120 comprises mapping the description “Hamburger 2A” to “Hamburger 1A” of Vendor₁, and “Hamburger NA” of Vendor_{N}. Accordingly, as seen in the example above, step 120 may comprise the mapping of a generic description of a good to description(s) of the good that correspond to particular vendor(s), or the mapping of a description of a good that corresponds to a particular vendor to description(s) of goods that correspond to different vendors.

Turning, once again, back to FIG. 2, following the performance of step 120, in an exemplary embodiment method 100 comprises a step 122 of displaying the description(s) to which the first description was mapped in step 120. This may comprise, for example, communicating the description(s) from central server 14 (or processing unit 24, if applicable) to user input device 12, and displaying the description(s) on user input device 12, and a display device (e.g., screen, monitor, etc.) thereof, in particular. This communication may be facilitated using, in an exemplary embodiment, communication network 16 and techniques and protocols well known in art, such as those described above.

More particularly, in an exemplary embodiment, a user interface, such as user interface 18₄ depicted in FIG. 7, may be generated by central server 14, for example, and communicated to and displayed on user input device 12. As illustrated in FIG. 7, the user interface may comprise a listing of the vendors and a description of the good(s) or products thereof to which the first description of a good was mapped. In other exemplary embodiments, additional information, or links to such information rather than the information itself, may also be displayed. For instance, as illustrated in FIG. 7, for each identified vendor, information relating to, for example and without limitation: pricing; vendor locations; relative distance between a given location (i.e., a location defined by a user or acquired via GPS, for example) and a vendor location; estimated travel time to a vendor location; and a link to a map showing the vendor's location(s) may also be displayed. Additional information may also include, for example: special promotions being offered by a vendor; estimated wait times at a vendor location; estimated delivery times for a vendor; and an identification of differences between the vendor's good and the first description of the good.

Further, in certain instances, in addition to or instead of the name of a vendor or the name of a particular vendor's good or product being displayed, a graphical representation (e.g., photograph, illustration, etc.) representative of the vendor and/or the good or product may be displayed. Additionally, in certain embodiments, in addition to or instead of the name of a vendor or the name of a particular vendor's good or product being displayed, an audible and/or visual pronunciation of the vendor's name or the name of a particular good may be displayed using, for example, a visual display of user input device 12 or a speaker thereof.

In an exemplary embodiment, all of the information that is displayed in step 122 is acquired from the data structure(s) stored in system 10, determined by central server 14, or acquired from other sources or components (e.g., memory devices) of system 10. Alternatively, in another embodiment, in a step 124 of method 100, some of the displayed information is acquired from information sources that may not be part of system 10, but that may be accessible by central server 14 or, if applicable, processing unit 24. For example, information relating to vendor location(s), traffic conditions (used for determining travel time or delivery time), distances between a given location and a vendor location, maps, and/or other types of information may be available from various information sources (e.g., websites, other servers, feeds, etc.) referenced in FIG. 1 with reference number 32, that are configured to collect and distribute such information. In an exemplary embodiment, and using techniques that are well known in the art, central server 14 or processing apparatus 24 may be configured to access and communicate with such information sources 32 to acquire the desired information/data. In an exemplary embodiment, this communication may be facilitated across communication network 16. Alternatively, rather than displaying the information itself, links (e.g., hyperlinks) to information sources 32 where the information is available may be provided instead.

In addition to the features and functionality described above, in an exemplary embodiment, method 100 may further allow for a user to select the language to be used in the performance of method 100. Accordingly, in an exemplary embodiment, method 100 may further comprise a step 126 of prompting a user to select or otherwise identify a desired language, and the user may then make a selection. In an exemplary embodiment, step 126 may be performed at any time or stage during the performance of the methodology, and may be implemented, for example, by presenting the user with a user interface on a user input device, such as user input device 12, that both prompts the user to make a selection or to indicate the particular language of interest and allows the user to make such a selection or indication. In an exemplary embodiment, any one of the user interfaces 18 (e.g., 18₁-18₄) described above may be used or modified to be used for step 126, or alternatively, a different interface may be employed. In any event, the descriptions of the various user interfaces set forth above apply here with equal force and will not be repeated; rather, they are incorporated here by reference. When a particular language is selected, all text that is displayed for a user's consumption during the performance of the method is in the selected language. In an exemplary embodiment, this text is stored in and accessible from one or more components of system 10; alternatively, the text may be acquired using techniques well known in the art from sources external to system 10 (e.g., language translation websites).

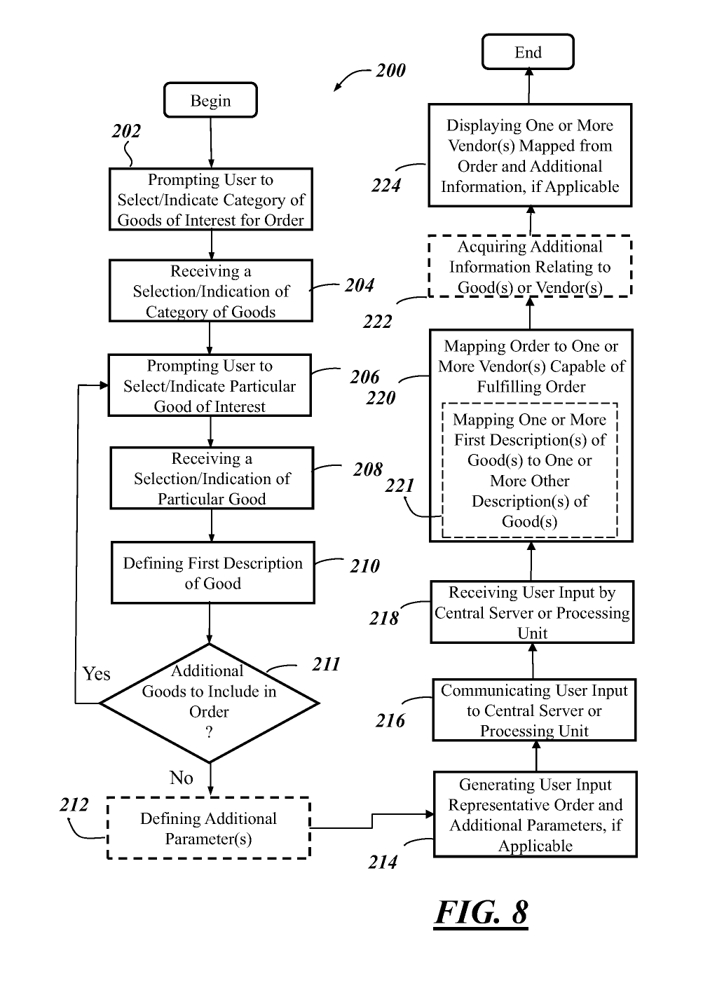

Referring now to FIG. 8, an exemplary embodiment of another methodology that may be implemented or performed using system 10 will be described. More particularly, FIG. 8 illustrates a method 200 for identifying one or more vendors that are capable of fulfilling an order for a plurality of different goods. As with method 100, it should be noted that while certain steps of method 200 will be described as being performed or carried out by central server 14 of system 10, in certain embodiments wherein system 10 includes one or more kiosks or displays, processing units 24 thereof may also be configured to perform or carry out some or all of those steps. Accordingly, it will be appreciated that the present disclosure is not meant to be limited to an embodiment wherein only central server 14 performs these steps, but rather embodiments wherein a processing unit 24 of a kiosk/display performs some or all of the steps remain within the spirit and scope of the disclosure.

Generally speaking, in many ways method 200 is very similar to method 100 and, in fact, includes many of steps thereof. For instance, in an exemplary embodiment, method 200 comprises a step 202 of prompting a user to select or otherwise indicate a particular category of goods that is of interest to them, and a step 204 of receiving the selection or indication from the user. Steps 202 and 204 are substantially the same as steps 102 and 104 of method 100, and therefore, the descriptions of step 102 and 104 set forth above apply here with equal weight and will not be repeated; rather, they are incorporated here by reference.

In an exemplary embodiment, in response to a user's selection of a particular category of goods, or in an embodiment where only one category of goods is supported, method 200 includes a step 206 of prompting a user to select or otherwise identify a first of a plurality of goods that are of interest to the user, and a step 208 of receiving such a selection from the user. Steps 206 and 208 are substantially the same as steps 106 and 108 of method 100, and therefore, the descriptions of steps 106 and 108 set forth above apply here with equal weight and will not be repeated; rather, they are incorporated here by reference.

As with method 100, in an exemplary embodiment, method 200 further comprises a step 210 of defining a first description of the good selected in step 208. Step 210 is substantially the same as step 110 of method 100, and therefore, the description of step 110 set forth above applies here with equal weight and will not be repeated; rather, it is incorporated here by reference.

Because method 200 relates to the fulfilling of an order of goods, in an exemplary embodiment, and following the defining of the good selected in step 208, method 200 comprises a step 211 of determining whether another good is to be added to the order being constructed. In one embodiment, once a good has been defined, a user may indicate that another good is to be added through a user-inputtable or user-selectable field of a user interface, such as, for example, user interface 18₂ illustrated in FIG. 4 (i.e., “Add Good” button). In such an embodiment, if there are no other goods to be added to the order, a user may indicate as much also through a user-inputtable or user-selectable field of a user interface, such as, for example, user interface 18₂ (i.e., “Next” button). Alternatively, following the defining of a good, the user may be prompted by a message inquiring as to whether there are any other goods to be added, and given the opportunity to answer such an inquiry (i.e., the message may include “YES” or “NO” buttons). In the event additional goods are to be added, method 200 loops back to step 206 and the steps 206-211 are repeated until it is determined that the order is complete and no other goods are to be added.

In another exemplary embodiment, rather than manually adding goods to an order one at a time, the user may be able to access one or more previously constructed orders that are part of a group profile. These descriptions may be stored on central server 14 (e.g., in memory device 24) and/or, in certain embodiments, processing units 24. Additionally, or in the alternative, the descriptions may be stored on user input device 12 that might include, for example, a group profile from a social networking environment. In any instance, a desired order may be selected by the user using user input device 12 in the same manner described above with respect to the creation of definitions of the goods of the order, the constructing of the order in step 211, etc. (e.g., utilizing a user interface displayed on a user input device).

Once it is determined in step 211 that no other goods are to be added to the order or that the order is otherwise complete, an optional step 212 of method 200 may be performed. Step 212 comprises defining additional parameters relating to the order. Because the user is using method 200 to find a vendor to fulfill an order of goods, certain parameters may have a bearing on the decision the user ultimately makes. These parameters may include, for example and without limitation: a desired vendor; a desired time for having the goods delivered to a particular location; a desired time for picking up the goods at a certain location; desired pricing for the goods; a location of the user; a desired location of a vendor; a relative distance between a given location and a vendor; and the like. Although step 112 of method 100 relates to a single good as opposed to an order of goods, step 212 of method 200 is otherwise substantially the same as step 112 of method 100, and therefore, the description of step 112 set forth above applies here with equal weight and will not be repeated; rather, it is incorporated here by reference.

Upon completing the construction of the order (i.e., the defining of each good thereof or the selection of a previously created order, and, if applicable, one or more additional parameters relating to the order), method 200 comprises a step 214 of generating a user input or user input signal that is representative of at least the order, and in certain instances, the order and any additional user-defined parameters defined in step 212. Following the generation of the user input in step 214, the user input is communicated, in a step 216, from user input device 12 to central server 14 (or, in certain embodiments, processing unit 24 of a kiosk/display of system 10), using known communication techniques and protocols such as, for example, those described above. Further, in an exemplary embodiment, the user input is communicated across communication network 16. In any event, in an exemplary embodiment, steps 214 and 216 may be precipitated by, and performed in response to, a command from the user made through user input device 12, and one or more user-inputtable or user-selectable fields of a user interface thereof, in particular (e.g., the “Submit” button of user interface 18₃ depicted in FIG. 5).

With continued reference to FIG. 8, method 200 further comprises a step 218 of receiving the user input generated in step 214 and communicated or transmitted in step 216. As described above, this user input may be received by, for example, central server 14 or, in certain embodiments, processing unit 24 of a kiosk/display of system 10. In either instance, the received user input is processed by a processing device, such as, for example, processing device 20 of central server 14 or, if applicable, that of processing unit 24, and the content thereof is used to identify one or more vendors that are capable of fulfilling the entire order represented by the user input. More particularly, a step 220 of method 200 comprises using the received user input and one or more data structures to map the order to one or more vendors capable of fulfilling the entire order. In an embodiment wherein the user input is representative of both the order and one or more additional user-defined parameters, step 220 comprises mapping the order and the additional parameter(s) to the one or more vendors capable of fulfilling the entire order. In either instance, each good of the order is processed and those vendors who have a good that corresponds or is equivalent to each good in the order are identified. Similarly, in one exemplary embodiment wherein additional user-defined parameters are also taken into account, each vendor that is identified as being capable of fulfilling the order is also evaluated to determine if they also meet each additional parameter. Alternatively, these parameters may be evaluated as each good of the order is being evaluated to see if a vendor has a corresponding or equivalent good or product.

In an exemplary embodiment, the order represented by the user input may comprise one or more descriptions of one or more goods that need to be translated into description(s) corresponding to particular goods of particular vendors. More particularly, in an exemplary embodiment, the order may comprise at least one good for which a first description thereof requires translation, and thus, the user input received in step 218 is further representative of the first description of that or those goods. In such an instance, and for each applicable good, mapping step 220 may further comprise a substep 221 of mapping the first description of the good to one or more other descriptions of the good that correspond to one or more particular vendors. This may be accomplished using the first description of the good and one or more appropriate data structures. The mapped description(s) may then be used in the mapping of the overall order to one or more particular vendors. In an exemplary embodiment, substep 221 is substantially the same as step 120 of method 100, and therefore, the description of step 120 set forth above applies here with equal weight and will not be repeated; rather, it is incorporated here by reference.

As described above, in an exemplary embodiment, step 220 involves the use of one or more data structures to perform the required mapping of the order to one or more vendors. In an embodiment wherein central server 14, and processing device 20 thereof, in particular, is performing step 220, the data structure(s) may be stored in memory device 22 of central server 14 (as is illustrated in FIG. 1 wherein data structure(s) 26 are shown being stored in memory device 22), or in another suitable memory device that is accessible by processing device 20. Similarly, in an embodiment wherein a processing unit 24 of a kiosk/display, and a processing device thereof, in particular, is performing step 220, the data structure(s) may be stored in a memory device of processing unit 24, or in another suitable memory device that is accessible by the processing device.

In an exemplary embodiment, a single data structure (e.g., look-up table), such as, for example, data structure 26₁ illustrated in FIG. 6, may be utilized in step 220; while in another embodiment multiple data structures (e.g., look-up tables) may be utilized (e.g., one data structure for each category of goods or each particular type of a good, one data structure for each vendor, different data structures based on the parameters to be taken into account in mapping, etc.). In either instance, each data structure may be single- or multi-dimensional, and may be populated with content in a number of ways, including, for example, those described above with respect to method 100; the description of which will not be repeated here. In any event, the content of the data structure(s) includes vendor information such as, for example and without limitation: names or designations the vendor uses to refer to their good(s); generic descriptions of their good(s); store location(s) where the good(s) may be obtained; current wait times for good(s) or delivery; pricing information; differences between their good(s) and certain other goods; or any other information that the data structure(s) may require or support. Accordingly, the data structure(s) used in step 220 are not limited in either number or content; rather any number of data structures containing any number of different types of content or information may be used depending, in part, on the particular implementation of system 10 and method 200.

Following the performance of step 220, in an exemplary embodiment method 200 comprises a step 222 of displaying the names of vendors that have been identified as being capable of fulfilling the entire order in step 220. This may comprise, for example, communicating the names of the vendor(s) from central server 14 (or processing unit 24, if applicable) to user input device 12, and displaying them on user input device 12, and a display device (e.g., screen, monitor, etc.) thereof, in particular. This communication may be facilitated using, in an exemplary embodiment, communication network 16 and techniques and protocols well known in the art, such as those described above.

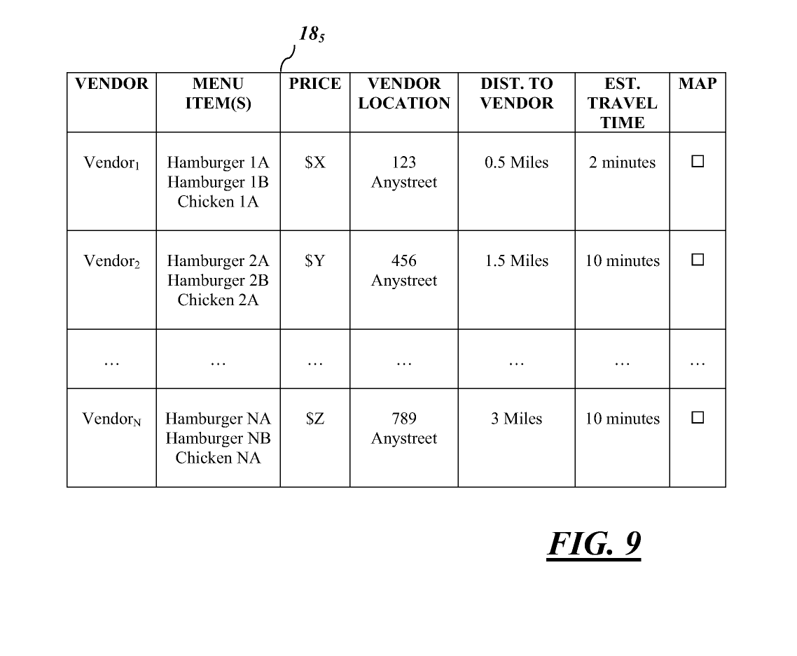

More particularly, in an exemplary embodiment, a user interface, such as user interface 18₅ depicted in FIG. 9, may be generated by central server 14, for example, and communicated to and displayed on user input device 12. As illustrated in FIG. 9, the user interface may comprise a listing of the vendors to which the order was mapped, and therefore that are capable of fulfilling the order. In other exemplary embodiments, additional information, or links to such information rather than the information itself, may also be displayed. For instance, as illustrated in FIG. 9, for each identified vendor, information relating to, for example and without limitation: the particular goods or products of the vendor corresponding to the order; pricing; vendor locations; relative distance between a given location (i.e., a location defined by a user or acquired via GPS from a user input device, for example) and a vendor location; estimated travel time to a vendor location; and a link to a map showing the vendor's location(s) may also be displayed. The additional information may further include, for example and without limitation: special promotions being offered by a vendor; estimated wait times at a vendor location; estimated delivery times for a vendor; and an identification of differences between the vendor's goods and those of the order; and the like.

Further, in certain instances, in addition to or instead of the name of a vendor or the name of a particular vendor's good(s) or product(s) being displayed, a graphical representation (e.g., photograph, illustration, etc.) representative of the vendor and/or the good(s) thereof may be displayed. Additionally, in certain embodiments, in addition to or instead of the name of a vendor or the name of a particular vendor's good(s) or product(s) being displayed, an audible and/or visual pronunciation of the vendor's name or the name of a particular good may be displayed using, for example, a visual display of user input device 12 or a speaker thereof.

As was described with respect to method 100 above, in an exemplary embodiment, all of the information that is displayed in step 222 is acquired from either the data structure(s) stored in system 10, determined by central server 14, or acquired from other sources or components (e.g., memory devices) of system 10. Alternatively, in another embodiment, in a step 224 of method 200, some of the displayed information is acquired from information sources that may not be part of system 10, but that may be accessible by central server 14 or, if applicable, processing unit 24. For example, information relating to vendor location(s), traffic conditions (used for determining travel time or delivery time), distances between a given location and a vendor location, maps, and/or other types of information may be available from various information sources (e.g., websites, other servers, feeds, etc.) referenced in FIG. 1 with reference number 32, that are configured to collect and distribute such information. In an exemplary embodiment, and using techniques that are well known in the art, central server 14 or processing apparatus 24 may be configured to access and communicate with such information sources 32 to acquire the desired information/data. In an exemplary embodiment, this communication may be facilitated across communication network 16. Alternatively, rather than displaying the information itself, links (e.g., hyperlinks) to information sources 32 where the information is available may be provided instead.

In addition to the features and functionality described above, and as with method 100, in an exemplary embodiment, method 200 may further allow for a user to select the language to be used in the performance of method 200. Accordingly, in an exemplary embodiment, method 200 may further comprise a step (not shown in FIG. 8) of prompting a user to select or otherwise identify a desired language, and the user may then make a selection. In an exemplary embodiment, this step may be performed at any time or stage during the performance of the methodology, and may be implemented, for example, by presenting the user with a user interface on a user input device, such as user input device 12, that both prompts the user to make a selection or to indicate the particular language of interest and allows the user to make such a selection or indication. In an exemplary embodiment, any one of the user interfaces 18 described above may be used or modified to be used for this step, or alternatively, a different interface may be employed. In any event, the descriptions of the various user interfaces set forth above apply here with equal force and will not be repeated; rather, they are incorporated here by reference. When a particular language is selected, all text that is displayed for a user's consumption during the performance of the method is in the selected language. In an exemplary embodiment, this text is stored in and accessible from one or more components of system 10; alternatively, the text may be acquired using techniques well known in the art from sources external to system 10 (e.g., language translation websites, other servers, etc.).

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method for translating a first description of a good into one or more other descriptions that correspond to one or more particular vendors, comprising the steps of:
receiving a user input representative of the first description of the good; and
mapping, using the received input and one or more data structures, the first description to one or more other descriptions of the good that correspond to one or more particular vendors.

2. The method of claim 1, wherein the first description of the good comprises at least one of a generic description of the good, a description of the good corresponding to a particular vendor, or a deconstruction of the good to its constituent parts.

3-4. (canceled)

5. The method of claim 1, wherein the input is further representative of one or more additional user-defined parameters, and further wherein the mapping step comprises mapping, using the received input and the one or more data structures, the first description of the good and the one or more additional user-defined parameters to the other descriptions of the good.

6. The method of claim 5, wherein the additional user-defined parameter(s) comprise one or more of:
a desired vendor;
a desired delivery time;
a desired pickup time;
desired pricing;
a location of the user;
a desired location of a vendor; and
a relative distance between a given location and a vendor.

7. The method of claim 1, further comprising the step of displaying the one or more other descriptions of the good on a display device.

8. The method of claim 7, wherein for each of the displayed one or more other descriptions of the good, the displaying step further comprises displaying additional information relating thereto, wherein the additional information comprises one or more of:
pricing information;
a promotion being offered with respect to the good;
a location of the vendor corresponding to the good;
a relative distance between a given location and the vendor;
an estimated delivery time for the good;
an estimated wait time for the good;
an estimated travel time to the vendor's location; and
an identification of any differences relative to the first description of the good.

9-12. (canceled)

13. The method of claim 1, further comprising the steps of:
defining the first description of the good based on one or more inputs from the user made via a user interface; and
generating the user input representative of the first description in response to the defining of the first description.

14. (canceled)

15. A system for translating a first description of a good into one or more other descriptions that correspond to one or more particular vendors, comprising:
a processing device; and
a memory device accessible by the processing device, the memory device containing one or more data structures configured for use in mapping the first description of the good to one or more other descriptions of the good that correspond to one or more particular vendors;
wherein the processing device is configured to:
receive a user input representative of the first description of the good; and
map, using the received input and the one or more data structures contained in the memory device, the first description to the one or more other descriptions of the good.

16. (canceled)

17. The system of claim 15, wherein the first description of the good comprises at least one of a generic description of the good and a description corresponding to a particular vendor, or a deconstruction of the good to its constituent parts.

18. (canceled)

19. The system of claim 15, wherein the received input is further representative of one or more additional user-defined parameters, and further wherein the processing device is configured to map, using the received input and the one or more data structures, the first description of the good and the one or more user-defined parameters to the other description(s) of the good.

20-28. (canceled)

29. The system of claim 15, further comprising a user input device configured for communication with the processing device, wherein the user input device is further configured to permit a user to define the first description of the good.

30-31. (canceled)

32. A method for identifying one or more vendors capable of fulfilling an order for a plurality of different goods, comprising the steps of:
receiving a user input representative of the order; and
mapping, using the received input and one or more data structures, the order to one or more vendors that are capable of fulfilling the entire order.

33-35. (canceled)

36. The method of claim 32, wherein the user input is further representative of one or more additional user-defined parameters, and further wherein the mapping step comprises mapping, using the received input and the one or more data structures, the order and the one or more additional user-defined parameters to the one or more vendors that are capable of fulfilling the entire order.

37. (canceled)

38. The method of claim 32, further comprising the step of displaying the one or more vendors that are capable of fulfilling the entire order on a display device.

39. The method of claim 38, wherein for each of the displayed one or more vendors, the displaying step further comprises displaying additional information relating thereto, wherein the additional information comprises one or more of:
pricing information;
a promotion being offered with respect to one or more of the goods;
a location of the vendor;
a relative distance between a given location and the vendor;
an estimated delivery time for the goods;
an estimated wait time for the goods; and
an estimated travel time to the vendor's location.

40. (canceled)

41. A system for identifying one or more vendors capable of fulfilling an order for a plurality of different goods, comprising:
a processing device; and
a memory device accessible by the processing device, the memory device containing one or more data structures configured for use in mapping the order to one or more vendors that are capable of fulfilling the entire order;
wherein the processing device is configured to:
receive a user input representative of the order; and
map, using the received input and the one or more data structures contained in the memory device, the order to one or more vendors that are capable of fulfilling the entire order.

42-43. (canceled)

44. The system of claim 41, wherein the user input is further representative of one or more additional user-defined parameters, and further wherein the processing device is configured to map, using the received input and the one or more data structures, the order and the one or more additional user-defined parameters to the one or more vendors that are capable of fulfilling the entire order.

45. (canceled)

46. The system of claim 41, further comprising a display device, and further wherein the processing device is configured to cause the one or more vendors capable of fulfilling the entire order to be displayed thereon.

47. (canceled)

48. The system of claim 46, wherein for each of the displayed one or more vendors, the processing device is further configured to cause additional information relating thereto to be displayed on the display device, wherein the additional information comprises one or more of:
pricing information;
a promotion being offered with respect to one or more of the goods;
a location of the vendor;
a relative distance between a given location and the vendor;
an estimated delivery time for the goods;
an estimated wait time for the goods; or
an estimated travel time to the vendor's location.

49-50. (canceled)

51. The system of claim 41, further comprising a user input device configured for communication with the processing device, wherein the user input device is further configured to permit a user to define the order.

52. (canceled)

53. The method of claim 41, wherein at least one of the one or more particular vendors comprises a kiosk.

54. The method of claim 41, wherein at least one of the plurality of different goods comprises a beverage.

55. The system of claim 1, wherein at least one of the one or more particular vendors comprises a kiosk.

56. The system of claim 1, wherein the good comprises a beverage.

57. The system of claim 15, wherein at least one of the one or more particular vendors comprises a kiosk.

58. The system of claim 15, wherein the good comprises a beverage.

59. The method of claim 32, wherein at least one of the one or more particular vendors comprises a kiosk.

60. The method of claim 32, wherein at least one of the plurality of different goods comprises a beverage.
